(19) United States
(12) Patent Application Publication
(10) Pub. No.: US 2013/0158890 A1
(43) Pub. Date: Jun. 20, 2013

(54) METHODS FOR EVALUATING GREEN DIESEL FUEL COMPOSITIONS

(71) Applicants: Haiyan Wang, Hoffman Estates, IL (US); Hung A. Pham, Des Plaines, IL (US); Wayne E. Rathbun, Mt Prospect, IL (US); Paul P. Adams, Hartland, WI (US)

(72) Inventors: Haiyan Wang, Hoffman Estates, IL (US); Hung A. Pham, Des Plaines, IL (US); Wayne E. Rathbun, Mt Prospect, IL (US); Paul P. Adams, Hartland, WI (US)

(73) Assignee: UOP LLC, Des Plaines, IL (US)

(21) Appl. No.: 13/327,574

(22) Filed: Dec. 15, 2011

(51) Int. Cl. G01N 30/16; H01J 49/26; G06F 19/00

(52) U.S. Cl. 702/25; 73/61.43; 73/61.55; 250/282

(57) ABSTRACT

Methods for evaluating a diesel fuel are provided. In one embodiment, a method of evaluating a diesel fuel includes obtaining a testing sample from the diesel fuel and analyzing the testing sample to detect an amount of at least one selected component. The method also provides for determining if the diesel fuel is green depending on either detection of at least one selected component in the testing sample or observation of at least one non-normal molecular class distribution in the testing sample. Further, the specific component can indicate the specific biological feedstock used to produce the green diesel based on the molecular fingerprinting database.

### TECHNICAL FIELD

The present invention generally relates to methods for evaluating diesel fuel compositions, and more particularly relates to methods for evaluating green diesel fuels to detect amounts of selected components therein, and to determine if the diesel fuel is green based on one detected component or a group of detected components. Briefly, the present invention describes a process for determining if a diesel fuel is green and for identifying its biological source based on the detection of either one molecular fingerprinting component or a group of selected components.

### BACKGROUND

As the demand for fuels such as diesel increases worldwide there is growing interest in feedstock sources other than petroleum crude oil for producing the fuel. One such source is what has been termed biological feedstocks. These renewable biological feedstocks include, but are not limited to, plant oils such as corn, jatropha, camelina, rapeseed, canola, soybean and algal oils, animal fats such as tallow, and fish oils. Biological oils and fats can be converted into diesel fuel using many different processes, such as hydro-deoxygenation and hydro-isomerization processes.

Diesel fuel refers to a mixture of carbon chains that generally contain between 8 and 21 carbon atoms per molecule. Typically, diesel has a boiling point in the range of 180° C. to 360° C. Production of diesel fuel can be either petroleum-derived or biologically-sourced. Petroleum-derived diesel is produced from the fractional distillation of crude oil or refining products. On the other hand, biologically-sourced diesel fuel is derived from renewable feedstock, such as vegetable oils or animal fats and it is usually classified into two categories, biodiesel and green diesel.

Biodiesel mainly consists of long-chain alkyl esters while green diesel is primarily composed of hydrocarbons. Biodiesel is defined as the mono-alkyl ester product derived from lipid feedstock. Its chemical structure is distinctly different from petroleum-derived diesel, and biodiesel has somewhat different physical and chemical properties from petroleum-derived diesel. Green diesel is substantially chemically the same as petroleum-derived diesel, but it is made from recently living biomass. Unlike biodiesel, which is an ester and has different chemical properties from petroleum diesel, green diesel is composed of long-chain hydrocarbons, and can be mixed with petroleum diesel in any proportion for use as transportation fuel. Biodiesel has a much higher oxygen content than petroleum-derived diesel. However, green diesel resembles petroleum-derived diesel fuel and usually has a very low heteroatom (nitrogen, oxygen, sulfur) content.

The use of biologically-sourced diesel fuel is desirable for a variety of reasons. In addition to ecological benefits of using biologically-sourced diesel fuel, there exists a market demand for such fuel. For diesel purchasers, the use of biologically-sourced diesel fuel can be promoted in public relations. Also, certain governmental policies may require or reward use of biologically-sourced fuels.

Thus, a potential diesel fuel purchaser may wish to determine if fuel is biologically-sourced and to discourage its suppliers' production of diesel fuel from undesirable petroleum feedstock. Therefore, diesel fuel purchasers or suppliers may need to be able to determine and show that a diesel fuel is biologically-sourced. While biodiesel can be easily discernable from petroleum-derived fuels because of high oxygen content, this is generally not the case for green diesel. Specifically, green diesel formed from complete deoxygenation of biological feedstocks is mostly composed of the same components as petroleum-derived diesel fuel. For instance, paraffins in green diesel, by themselves, are not distinguishable from paraffins in petroleum-derived diesel.

Accordingly, it is desirable to provide methods for evaluating a diesel fuel to determine whether the fuel is green. Further, it is desirable to provide methods for detecting selected components in a diesel fuel to determine if the diesel fuel is green. Also, it is desirable to provide methods for evaluating a distribution of selected components in a diesel fuel for determination of whether the diesel fuel is green. It is also desirable to provide methods for identifying feedstock source for green diesel. Furthermore, other desirable features and characteristics will become apparent from the subsequent detailed description and the appended claims, taken in conjunction with the accompanying drawings and the foregoing technical field and background.

### BRIEF SUMMARY

Methods for evaluating diesel fuel are provided to determine if the diesel fuel is green. In accordance with an exemplary embodiment, a method of evaluating diesel fuel includes obtaining a testing sample from the diesel fuel. Also, the method includes analyzing the testing sample to detect an amount of at least one selected component. The method also provides for determining if the diesel fuel is green based on a detected amount of the selected component(s). Furthermore, a molecular finger-printing database can be built based on the detected component(s), information of the biological feedstock and process conditions. Such a database can then be applied to determine whether an unknown diesel fuel is green and its biological source.

In accordance with another exemplary embodiment, a method of evaluating if a diesel fuel is green includes obtaining a testing sample from the diesel fuel. The method also includes analyzing the testing sample to detect amounts of components within a selected molecular class. The detected amounts of the components form a distribution. The method further includes determining if the diesel fuel is green based on the distribution of the detected amounts of the selected components.

In accordance with another exemplary embodiment, a method of evaluating a diesel fuel includes obtaining a testing sample of the diesel fuel and analyzing the testing sample using a comprehensive two dimensional gas chromatography system to detect an amount of a selected component or a group of molecules. Also, the method includes determining if the diesel fuel is green based on a detected amount of the selected component(s).

### BRIEF DESCRIPTION OF THE DRAWINGS

The methods for evaluating fuel will hereinafter be described in conjunction with the following drawing figures, wherein like numerals denote like elements, and wherein:

FIG. 1 is a flow chart illustrating an exemplary method for evaluating a diesel fuel in accordance with an embodiment herein;

FIG. 2 is a contour plot of a green diesel fuel testing portion obtained from a comprehensive two dimensional gas chromatograph coupled with a time-of-flight mass spectrometer in accordance with various embodiments herein; and

FIG. 3 is a contour plot of a biologically-sourced diesel fuel testing portion obtained from a comprehensive two dimensional gas chromatograph coupled with a flame ionization detector in accordance with various embodiments herein.

### DETAILED DESCRIPTION

The following Detailed Description is merely exemplary in nature and is not intended to limit the methods of evaluating diesel fuels. Furthermore, there is no intention to be bound by any expressed or implied theory presented in the preceding technical field, background or brief summary, or in the following detailed description.

Various methods for evaluating diesel fuel compositions are provided herein. The methods can be employed to determine if a diesel fuel composition is green based on either of two testable conditions. The first condition is the presence of at least one selected component that is a green indicator. In other words, the detection of any amount of such a selected component or a group of compounds indicates that the diesel fuel is green. Selected components that are indicators of green diesel fuel include polynaphthenes and other molecules that are unique to the biological sources. Furthermore, a molecular fingerprinting database is constructed based on biological sources and process conditions. In this database, one or a group of molecules which are not detectable in the petroleum-derived diesel fuels are linked to a specific biological feedstock. For example, isomers of C₁₉H₃₄ polynaphthenes, such as 18-Norabietane or Fichtelite, or Stigmastanes, can indicate the particular biological feedstock used in the green diesel production. The second condition indicative of a green diesel is a non-Gaussian distribution of compounds within a selected molecular class, particularly within the normal paraffin class, the single ring aromatic class, or the isoparaffin class. In other words, the detection of measured amounts of selected compounds within a molecular class forming a distribution that is non-normal, or non-Gaussian, indicates that the diesel fuel is green. Petroleum-derived diesels do not exhibit such non-Gaussian distributions within these selected molecular classes.

For analysis, compounds in a testing sample are separated, such as by comprehensive two dimensional gas chromatography, and are analyzed to detect the selected components. The separated compounds can be analyzed by a flame ionization detector or time-of-flight mass spectrometer to detect selected components. As noted above, when determination that a diesel fuel is green relies on the presence of at least one selected component such as a polynaphthene, detection may include the mere identification of a detectible level of the selected component. When determination of green diesel relies on the presence of a non-Gaussian distribution of selected components within a molecular class, detection requires measurement of the amounts of the selected components.

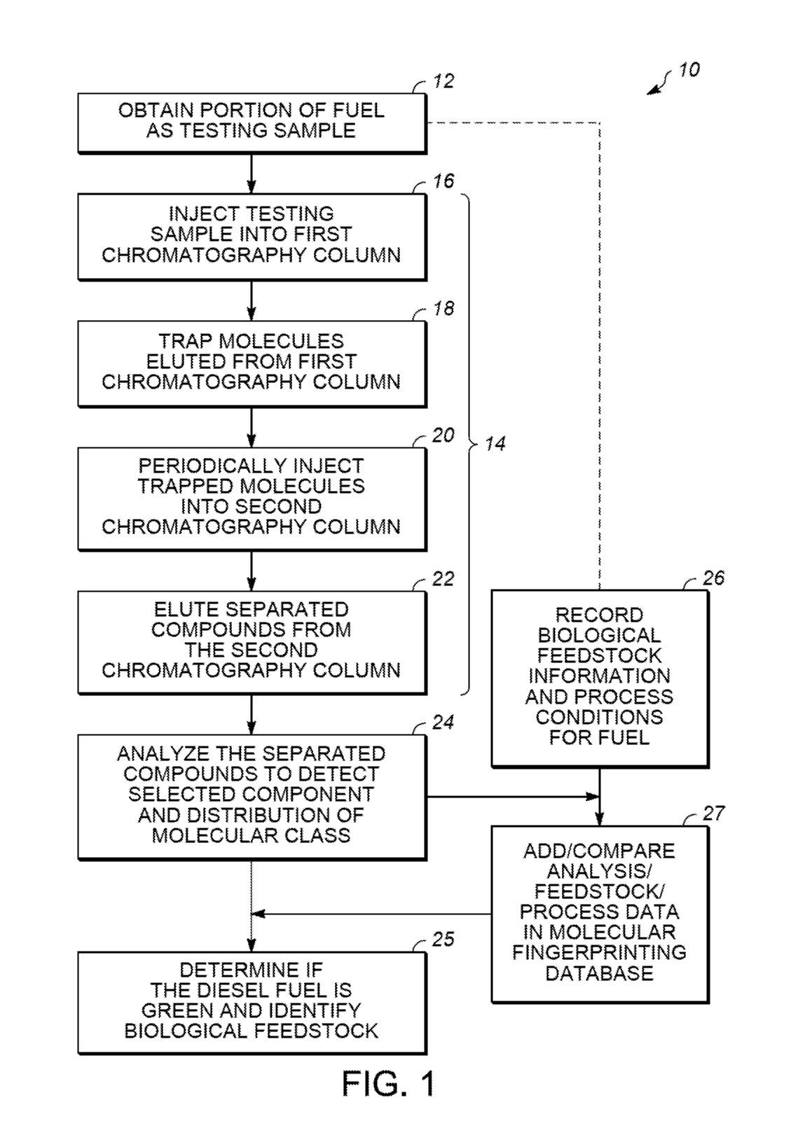

In accordance with an exemplary embodiment, FIG. 1 illustrates a method 10 for evaluating if a diesel fuel is biologically-sourced. The method 10 begins by obtaining a portion of the fuel as a testing sample (step 12). Typically, the fuel sample is obtained and stored at ambient temperature. The testing sample may be obtained from a post-fractionated diesel fuel product (e.g., boiling points between 180° C. and 360° C.), or from a post-fractionated diesel fuel heavy cut byproduct (e.g., boiling points above 360° C.).

The testing sample is then separated so that the compounds in the testing sample can be analyzed (step 14). In the exemplary embodiment, the compounds are separated by a comprehensive two dimensional gas chromatograph. The comprehensive two dimensional gas chromatograph is sold by multiple vendors, such as Zoex Corporation, of Houston, Tex., as Model No. ZX1; and LECO Corporation, of St. Joseph, Mich., as Model GCxGC with Liquid Nitrogen Cooled Thermal Modulator or Model GCxGC with Consumable-Free Modulator. A suitable comprehensive two dimensional gas chromatograph coupled with a mass spectrometry detector is also provided by multiple vendors, such as LECO Corporation, of St. Joseph, Mich., as Model Pegasus 4D.

During separation, a certain volume of the testing sample (e.g., 0.1 μL) is injected into a first chromatography column of a comprehensive two dimensional gas chromatography system (step 16). A typical gas chromatography column is a 50 meter fused silica capillary with an internal diameter of 0.20 mm, internally coated to a film thickness of 0.5 μm with cross-linked methyl silicone. An exemplary column is sold by Agilent Technologies under catalog no. 19091S-001.

In an exemplary embodiment, the testing sample can be delivered into an autosampler vial with a Pasteur pipette. The gas chromatograph inlet is run in the split injection mode with a split flow ratio of 100:1. The instrument port temperature is 280° C. for the vaporization of the sample for analysis. The gas chromatograph oven program is initially 40° C. for 10 minutes after sample injection. Then the temperature is ramped to 153° C. at 1.5° C./min and then to 280° C. at 2.0° C./min for a final hold time of 11.17 minutes. The total analysis time is approximately 160 minutes. After the sample is evaporated in the instrument inlet, it is split between the first column and a split vent. In the first column, molecules are separated and then eluted.

Next, the eluted molecules are trapped by a modulator (step 18). The modulator then periodically injects the trapped molecules into a second chromatography column (step 20). Typically, the molecules are injected at intervals of between about 4 and about 10 seconds by the modulator. Compounds are separated in the second chromatography column and are eluted from the column (step 22). An exemplary second chromatography column is a 20 meter fused silica capillary with an internal diameter of 0.10 mm, which is internally coated to a film thickness of 0.2 μm with polyethylene glycol. Such a column is sold by Agilent Technologies, under Cat. No. 127-7023. Only 1.9 to 2.0 meters of the column is typically used during the process.

As a result of steps 16 through 22, compounds within the diesel fuel are separated. The compounds are then analyzed to detect an amount of a selected component, or amounts of selected components (step 24). Further, a distribution of selected components within a molecular class may be detected. In the process, the separated compounds are fed into a detector, such as a flame ionization detector (FID) or a time-of-flight (TOF) mass spectrometer (MS). A flame ionization detector is able to quantify or precisely measure the amount of components in the volume of separated compounds it receives. A time-of-flight mass spectrometer is particularly suited to identifying the components within the volume of separated compounds.

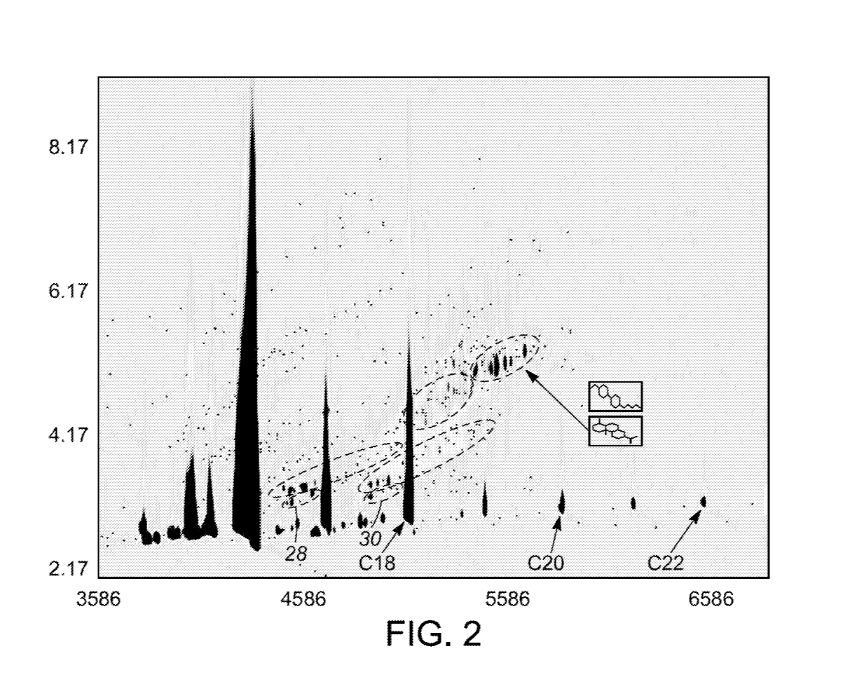

Based on the identification and detection of selected components within the volume of separated compounds, the method may determine whether the diesel fuel is green (step 25). For example, it is contemplated herein that polynaphthenes distributed within a narrow boiling point range are typically present in green diesel fuels at easily detected levels, but are not found within petroleum-derived diesels. For instance, detectible levels of C₁₉H₃₄ polynaphthenes such as 18-Norabietane (or Fichtelite) and its isomers, are exclusively found in particular green diesel fuels. Therefore, if any amount of specific indicators is detected during analysis in step 24, then it can be determined that the diesel fuel is green in step 25. Referring to FIG. 2, the contour plot created by analysis of separated compounds separated from a diesel fuel illustrates that the separated compounds include C₁₇ naphthenes at reference number 28 and C₁₈ naphthenes at reference number 30. Based on these detected amounts, the diesel fuel under testing is determined to be green. Further, the biological source used to produce this green diesel can be determined based on the molecular fingerprinting database.

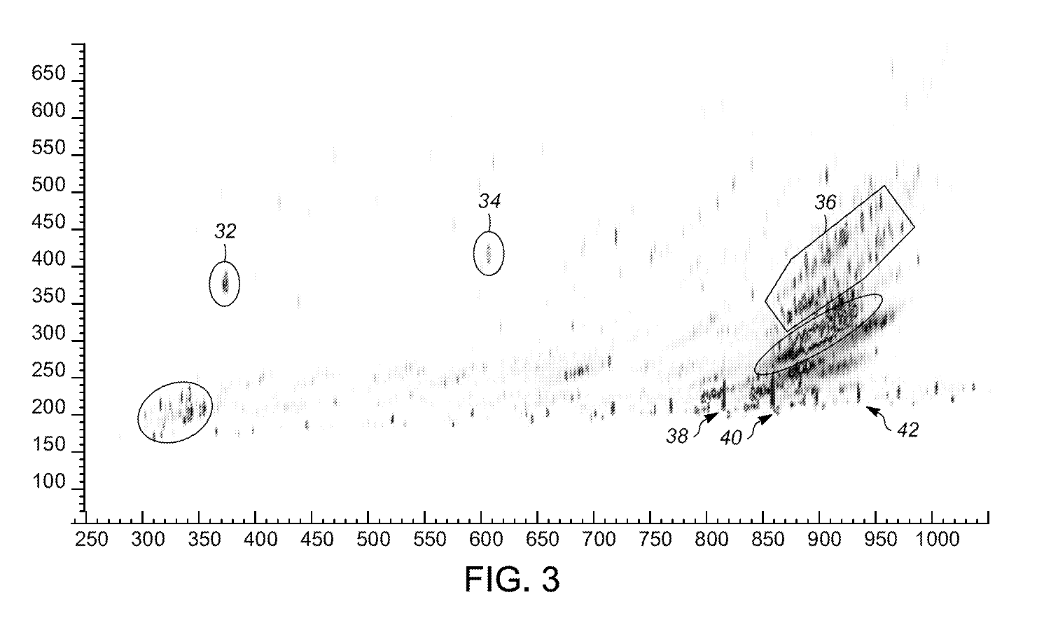

It is also contemplated herein that green diesel fuels include non-normal or non-Gaussian distributions of certain molecular types, such as normal paraffins, single ring aromatics, and isoparaffins, unlike petroleum-derived diesel fuels. For example, a petroleum-derived diesel fuel will include a Gaussian distribution of single ring aromatics, from light or lower boiling point compounds to heavy or higher boiling point compounds. On the other hand, green diesel fuels will include a distribution of single ring aromatics that is not Gaussian. FIG. 3 is a contour plot resulting from flame ionization detection, and illustrates a non-Gaussian distribution of single ring aromatics. As shown, the testing sample includes at reference number 32 about 0.6 wt % C₁₀ single ring aromatics, at reference number 34 about 0.2 wt % C₁₂ single ring aromatics, and at reference number 36 about 4.8 wt % heavy single ring aromatics. Such a non-normal distribution of single ring aromatics is not seen in petroleum-derived biodiesels and indicates that the diesel fuel is green. Further, FIG. 3 shows at respective reference numbers 38, 40 and 42, C₁₇ normal paraffins form about 16.9 wt % of the sample, C₁₈ normal paraffins form about 27.9 wt % of the sample, and C₂₀ normal paraffins form about 2.4 wt % of the sample. Further, the C₁₇ and C₁₈ normal paraffins form about 80 wt % of all normal paraffins in the testing sample. Again, such a non-Gaussian distribution is indicative of a green diesel fuel.

Referring again to FIG. 1, the biological feedstock of the green diesel may also be identified at step 25. Specifically, information relating to the biological feedstock and the processing conditions of the fuel from step 12 may be recorded at step 26. The analysis data from step 24 and the information from step 26 may be added and compared to existing data and information in a molecular fingerprinting database (step 27). As a result of the comparison to the molecular fingerprinting database, step 25 may identify the biological feedstock of the green diesel.

In accordance with an alternative exemplary embodiment, the testing sample is obtained from a heavy cut byproduct in diesel fuel production. Therefore, the method may further include the step of diluting the heavy cut with a solvent, such as carbon disulfide and toluene. The heavy cut can also be processed as above with modified experimental conditions and/or analyzed using high resolution mass spectrometry (HRMS) to detect the amount of selected components. For example, it has been found that cholesterol derivatives such as Stigmastanes and Stigmastane isomers are detected at measurable levels for a group of green diesels. Such cholesterol derivatives are not found at detectible levels in the petroleum-derived heavy cut byproduct and can be used as the selected component indicative of those green diesel fuels.

Accordingly, the evaluation methods described herein can be used to evaluate diesel fuels, to analyze compounds separated from the diesel fuels, to detect selected components within diesel fuels, and to evaluate whether a diesel fuel is green based on a detected amount of the selected component. Further, the determination can be made based on the detection of any biological indicator components, such as polynaphthenes, or based on the non-Gaussian distribution of certain molecular types in the diesel fuel, such as normal paraffins, single ring aromatics, and isoparaffins.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of filing this patent application.

What is claimed is:

1. A method of evaluating a diesel fuel, the method comprising the steps of:
obtaining a testing sample from the diesel fuel;
analyzing the testing sample to detect an amount of a selected component; and
determining if the diesel fuel is green based on a detected amount of the selected component.

2. The method of claim 1 wherein the diesel fuel is formulated from a selected feedstock at selected process conditions, the method further comprising the steps of:
constructing a molecular fingerprinting database based on the selected component, selected feedstock information and selected process conditions; and
identifying the biological feedstock of the diesel fuel based on the molecular fingerprinting database.

3. The method of claim 1 wherein analyzing comprises detecting the amount of the selected component, and wherein the selected component is a polynaphthene.

4. The method of claim 1 wherein analyzing comprises detecting amounts of selected components, wherein the amounts of the selected components form a distribution, and wherein determining is based on the distribution of the amounts of the selected components.

5. The method of claim 4 wherein determining comprises comparing the distribution of the amounts of the selected components to a Gaussian distribution, and wherein the diesel fuel is green if the distribution is not Gaussian.

6. The method of claim 4 wherein the selected components are chosen from the group comprising normal paraffins, single ring aromatics, and isoparaffins; wherein determining comprises comparing the distribution of the amounts of the selected components to a Gaussian distribution; and wherein the diesel fuel is green if the distribution is not Gaussian.

7. The method of claim 1 wherein analyzing comprises:
injecting the testing sample into a first gas chromatography column;
trapping molecules eluted from the first gas chromatography column;
periodically injecting selected trapped molecules into a second gas chromatography column;
eluting separated compounds from the second gas chromatography column; and
analyzing the separated compounds to detect the amount of the selected component.

8. The method of claim 7 wherein analyzing comprises feeding the eluted separated compounds to a flame ionization detector for quantitation or feeding the eluted separated compounds to a time-of-flight mass spectrometer for identification.

9. The method of claim 1 wherein obtaining comprises diluting a heavy cut of the diesel fuel to form the testing sample, and wherein analyzing comprises performing comprehensive two dimensional gas chromatography and/or high resolution mass spectrometry on the sample.

10. The method of claim 9 wherein analyzing comprises detecting the amount of the selected component, and wherein the selected component is a polynaphthene.

11. The method of claim 9 wherein analyzing comprises detecting the amount of the selected component, and wherein the selected component is a cholesterol derivative.

12. A method of evaluating if a diesel fuel is green, the method comprising the steps of:
obtaining a testing sample from the diesel fuel;
analyzing the testing sample to detect amounts of components within a selected molecular class, wherein the amounts of the components form a distribution;
determining if the diesel fuel is green based on the distribution of the detected amounts of the components within the selected molecular class.

13. The method of claim 12 wherein analyzing comprises detecting amounts of the components within the selected molecular class, and wherein the selected molecular class is chosen from the group comprising normal paraffins, single ring aromatics, and isoparaffins.

14. The method of claim 12 wherein determining comprises comparing the distribution of the amounts of the components to a Gaussian distribution, and wherein the diesel fuel is green if the distribution is not Gaussian.

15. The method of claim 14 wherein analyzing comprises detecting amounts of the components within the selected molecular class, and wherein the selected molecular class is chosen from the group comprising normal paraffins, single ring aromatics, and isoparaffins.

16. The method of claim 12 wherein obtaining comprises diluting a heavy cut of the diesel fuel to form the testing sample, and wherein analyzing comprises performing comprehensive two dimensional gas chromatography and/or high resolution mass spectrometry on the testing sample.

17. A method of evaluating a diesel fuel, the method comprising the steps of:
obtaining a testing sample of the diesel fuel;
analyzing the testing sample using a two dimensional gas chromatography system to detect an amount of a selected component; and
determining if the diesel fuel is green based on a detected amount of the selected component.

18. The method of claim 17 wherein analyzing comprises detecting the amount of the selected component, and wherein the selected component is a polynaphthene.

19. The method of claim 17 wherein analyzing comprises detecting amounts of selected components, wherein the amounts of the selected components form a distribution, wherein determining comprises comparing the distribution of the amounts of the selected components to a Gaussian distribution, and wherein the diesel fuel is green if the distribution is not Gaussian.

20. The method of claim 17 wherein analyzing comprises detecting amounts of selected components from a molecular class, wherein the molecular class is chosen from the group comprising normal paraffins, single ring aromatics, and isoparaffins; wherein the amounts of the selected components form a distribution; wherein determining comprises comparing the distribution of the amounts of the selected components to a Gaussian distribution; and wherein the diesel fuel is green if the distribution is not Gaussian.
